(19) United States
(12) Patent Application Publication
(10) Pub. No.: US 2026/0077437 A1
(43) Pub. Date: Mar. 19, 2026

(54) SEAL APPLICATION APPARATUS WITH PRESSING ROLLER COMPRISING MULTIPLE ELEMENTS

(71) Applicants: thyssenkrupp Automotive Body Solutions GmbH, Heilbronn (DE); thyssenkrupp AG, Essen (DE)

(72) Inventor: Marc SCHNEIDER, Tholey (DE)

(73) Assignees: thyssenkrupp Automotive Body Solutions GmbH, Heilbronn (DE); thyssenkrupp AG, Essen (DE)

(21) Appl. No.: 19/330,532

(22) Filed: Sep. 16, 2025

(30) Foreign Application Priority Data
Sep. 17, 2024 (DE) 10 2024 126 819.0

(51) Int. Cl. B23P 19/04

(52) U.S. Cl. CPC B23P 19/047

(57) ABSTRACT

An application apparatus for applying a seal profile to a body component serving to close a body opening comprises a roll-on head for applying the seal profile to a receiving surface of the body component and a cleaning unit intended for mechanical cleaning of the receiving surface and positioned at the front of the roll-on head with respect to the receiving surface of the body component, wherein the cleaning unit comprises a pressing roller. The pressing roller comprises a roller base element made of a first material extending over the width of the pressing roller. The pressing roller further comprises a roller center element made of a second material arranged centrally on the roller base element and having a smaller width than the roller base element. In addition, the pressing roller comprises a roller outer element made of a third material, wherein the roller outer element is arranged on the roller base element so as to surround the roller center element and is arranged on the roller center element. The third material has a lower hardness than the second material and the first material.

### CROSS REFERENCE TO RELATED APPLICATION

This application is a U.S. Non-Provisional that claims priority to German Patent Application No. DE 10 2024 126 819.0, filed Sep. 17, 2024, the entire content of which is incorporated herein by reference.

### FIELD

The present disclosure relates to an application apparatus for applying a seal profile to a body component serving to close a body opening.

### BACKGROUND

The seal profiles applied to the body component are intended in particular for a seal-tight connection between a body opening and the closure element inserted therein. Such a closure element may in particular be a door, a boot lid or a sliding roof element. The following text describes a vehicle door by way of example; at the stage in which the seal profile is mounted on the vehicle door, it is also possible to make reference to a door assembly. For example, a method for mounting a seal profile on a door assembly, referred to as “direct rolling-on”, is known. Here, the seal profile is conveyed from an endless roll by means of a conveyor and applied via a roll-on head. The feed of the seal profile onto the door assembly is correspondingly regulated. The door assembly per se is movably received in a movable attachment apparatus, for example via an industrial robot, and is guided past the stationary roll-on head, which in the process applies the seal profile to the door assembly. Once the seal profile has been applied around the door assembly, a cutting blade severs the seal profile, in order to cut it to length from the endless roll. After that, the two abutting ends must be brought closer together in such a way that as far as possible a virtually seamless, continuous seal profile is produced. Such application is, however, also possible with a mobile application head, as disclosed for example in DE 10 2022 206 369 B4, the application head for applying the seal profile being guided along the body component, which is fixed in place.

The seal is generally applied within the normal production environment, in which dust-free conditions cannot be ensured. Due to handling processes, it is also not possible to prevent a film of lubricant from being deposited on the body component. In order to ensure good bonding quality, at least the receiving surface of the body component must be free of dust, moisture and lubricant residues. These impurities can be removed by a cleaning unit which is part of the application apparatus, in particular as described in DE 10 2017 221 018 B3. The leading pressing roller of the cleaning unit is set to the required Y coordinate and pressed onto the body component by way of a mechanical cleaning element, in particular a cleaning fleece, via an in particular pneumatic spring mechanism.

It has proven to be disadvantageous in this case that, in the case of complex component geometries, in particular in the region of what are referred to as S twists or in the region of corners, unsatisfactory cleaning results are obtained, in particular because it is not possible, or is possible only to an insufficient extent, to compensate for angular deviations of a component flange.

Thus a need exists to provide an application apparatus having an improved cleaning unit with which better cleaning results in the case of complex component geometries, in particular in the region of S twists or in the region of corners, can be obtained.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a perspective illustration of an exemplary embodiment of an application apparatus configured according to the invention.

FIG. 2 shows a perspective illustration of a detail of a further exemplary embodiment of an application apparatus designed according to the invention.

FIG. 3 shows a sectional illustration, along a direction of longitudinal extent of a pressing roller, of an exemplary embodiment of the pressing roller designed according to the invention for the cleaning unit of an application apparatus.

FIGS. 4a to 4c each show a sectional illustration of the pressing roller according to FIG. 3 when to bearing against a receiving surface aligned differently in the various illustrations in relation to the pressing roller.

FIG. 5 shows a sectional illustration, along a direction of longitudinal extent of a pressing roller, of a further exemplary embodiment of the pressing roller designed according to the invention for the cleaning unit of an application apparatus.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to an application apparatus for applying a seal profile to a body component serving to close a body opening, comprising a roll-on head for applying the seal profile to a receiving surface of the body component and a cleaning unit intended for mechanical cleaning of the receiving surface and positioned at the front of the roll-on head with respect to the receiving surface of the body component, wherein the cleaning unit comprises a pressing roller designed in particular to press a cleaning element against the receiving surface. An application apparatus of the type in question is described in detail in DE 10 2017 221 018 B3. A further application apparatus of the type in question is disclosed in DE 10 2022 206 369 B4 The proposed solution provides an application apparatus for applying a seal profile to a body component serving to close a body opening, wherein the application apparatus comprises a roll-on head for applying the seal profile to a receiving surface of the body component and a cleaning unit intended for mechanical cleaning of the receiving surface and positioned at the front of the roll-on head with respect to the receiving surface of the body component. The cleaning unit comprises a pressing roller comprising: a roller base element which is rotationally symmetrical with respect to an axis of rotation of the pressing roller and is made of a first material; a roller center element which is rotationally symmetrical with respect to the axis of rotation of the pressing roller and is made of a second material; and a roller outer element which is rotationally symmetrical with respect to the axis of rotation of the pressing roller and is made of a third material. The third material has a lower hardness, in particular a lower hardness value, more particularly a lower Shore hardness, than the second material and the first material. It is further provided in particular that the roller base element extends over the width of the pressing roller, that the roller center element is arranged centrally with respect to the roller base element and has, at least in a region of a largest diameter of the roller center element, a smaller width than the roller base element, and that the roller outer element is arranged on the roller base element so as to surround the roller center element and is arranged on the roller center element.

Advantageously, the effect of this pressing roller comprising materials of different hardnesses, or different elasticities, is that angular deviations of a component flange of a receiving surface of the body component can be compensated for by the pressing roller “rebounding”, the material of the roller outer element advantageously being significantly softer than that of the roller center element.

In addition, it is provided in particular that the cleaning unit further comprises a mechanical cleaning element and is advantageously designed to apply the cleaning element along the receiving surface with a circular movement independently of the application movement of the roll-on head, the pressing roller advantageously being designed to press the cleaning element against the receiving surface. The mechanical cleaning element is in particular a cleaning fleece passed over the pressing roller. In this respect, the term “mechanical cleaning element” refers to the physical operating principle according to which impurities are removed by physical contact between the cleaning element and the surface that is to be cleaned. Advantageously, the cleaning unit is configured such that the cleaning element can perform an independently controlled circular movement, which can be superposed on the actual application movement and does not completely depend thereon.

The rotational speed and thus the intensity of the cleaning can therefore advantageously be adapted depending on the degree of contamination. In particular, it can be provided that the cleaning element per se does not perform any inherent circular movement at all during the application process, but only moves at the application speed along the surface that is to be cleaned. In particular, it can alternatively however also be provided that the cleaning element per se performs an inherent circular movement. If the rotational speed of the cleaning element is rather low, the superposition with the application movement results in a speed of the cleaning element with respect to the receiving surface which is only negligibly higher than the application speed. However, the rotational speed of the cleaning element can also be set relatively high, especially if the degree of contamination of the receiving surface is high. This can, however, lead to a greater degree of wear and/or a shorter interval between cleaning element replacements. The term “positioned at the front of” means in particular that the cleaning unit is positioned in relation to the roll-on head in such a way that—when viewed in the application direction—the cleaning unit contacts a location on the receiving surface of the body component before this same location is traversed by the roll-on head for applying the seal profile.

The application apparatus itself can be in the form of a stationary application apparatus or a mobile application apparatus arranged in particular on a robot arm.

It is further provided in particular that the cleaning apparatus comprises a roller assembly, the pressing roller in turn being part of the roller assembly. Advantageously, the roller assembly can be driven, in order to set the cleaning element in circular motion. A roller assembly has the advantage that it can be used to guide a cleaning element in a flexible configuration. Moreover, the cleaning element can be driven with low friction via a roller assembly. The pressing roller presses the cleaning element against the receiving surface, it advantageously being possible to deliberately influence the pressing behaviour of the cleaning element against the receiving surface via the pressing roller. In this case, it can in particular also be provided that the roller assembly has a movement, in particular rotational or linear movement, via which the pressing roller can be fed in relation to the receiving surface. The feed movement advantageously also allows the pressing roller, in particular the roller outer element of the pressing roller, to be deliberately deformed.

In particular, one configuration of the application apparatus provides that the roller base element is formed in one piece together with the roller center element. In this case, the first material then of course corresponds to the second material. In particular, the roller base element and the roller center element together form a roller base center element. The roller base element is defined in particular by the region of smallest diameter of the roller base center element on the outer sides of the pressing roller. The roller center element is defined in particular by the region of largest diameter of the roller base center element. The roller base center element is preferably made of metal and the roller outer element is preferably made of polyurethane.

An advantageous configuration variant, which in particular has manufacturing advantages, by contrast provides that the roller base element together with the roller center element is not formed in one piece. The roller base element and the roller center element are in this case in particular different, separate interconnected elements. Advantageously, this configuration allows the use of a cylindrical roller base element. The roller center element is advantageously arranged centrally on the roller base element. The first material of the roller base element and the second material of the roller center element are in this case in particular different, the second material advantageously having a lower hardness than the first material and the third material advantageously having a lower hardness than the second material. Advantageously, the second material and the third material are elastically deformable, the third material advantageously having a higher elasticity than the second material. The use of different materials for the roller base element and the roller center element advantageously also affords manufacturing advantages. Deviating from that, in this configuration it is however also possible for the first material and the second material to be the same or at least have the same hardness or substantially the same hardness.

According to one advantageous configuration, the roller base element of the pressing roller has a constant diameter over its direction of longitudinal extent. In particular, the roller base element may be in the form of a bushing, which may be mounted in particular on a shaft or a bearing, in particular in order to be able to set the cleaning element in a circular movement. Furthermore, the constant diameter results in manufacturing advantages, in particular if the roller base element is a separate component.

Further advantageously, the roller base element is at least partially made of metal, in particular completely made of metal. The metal provided is in particular aluminium, further particularly a hardenable aluminium alloy, which has proven to be particularly suitable. In this way, the pressing roller can be set in a stable movement and good durability can be obtained.

Furthermore, the roller center element of the pressing roller advantageously has a constant diameter over its direction of longitudinal extent, in particular if the roller center element is not formed in one piece with the roller base element. This results in further manufacturing advantages. In addition, in this way the roller center element is particularly suitable for the cleaning element to be able to be pressed onto the receiving surface that is to be cleaned with sufficient force. In this respect, a certain stability of the roller center element is also advantageous. In particular, one configuration provides that the roller center element is at least partially made of foam rubber, in particular completely made of foam rubber. A further, advantageous configuration provides that the roller center element is at least partially made of polyurethane, in particular completely made of polyurethane. Advantageously, the material of the roller center element has the following or similar material properties, similar material properties being in particular material properties having values which differ by up to 15%: resilience of 60%; compression hardness of 1.05 N/mm² (N: newtons; mm: millimetres) at 10% compression in the third loading cycle; static modulus of elasticity of 9.5 N/mm² at a pressure of 1.2 N/mm²; dynamic modulus of elasticity of 16 N/mm² at a pressure of 1.2 N/mm² and 10 Hz (Hz: hertz).

The roller outer element can also have a constant diameter over its direction of longitudinal extent. Advantageously, however, the pressing roller, in particular the roller outer element of the pressing roller, has “excess” soft material at the outer edges, as a result of which a stronger “rebound” effect can advantageously be achieved. According to a further, advantageous configuration, the roller outer element of the pressing roller therefore has a decreasing diameter from its outer sides to the center over its direction of longitudinal extent. The outer surface of the roller outer element may in this respect have in particular a substantially concave shape. Entirely different configurations can be provided for the specific contour of the outer surface of the roller outer element. A configuration which has proven to be particularly advantageous provides that the diameter of the roller outer element linearly decreases from each outer side of the roller outer element to the center of the roller outer element. In this respect, the pressing roller in particular has the shape of two cone frustums arranged one on top of the other and connected to each other by the frustums. Particularly good cleaning results were obtained even on complex component geometries, especially in the region of S twists and in the region of corners, with advantageous configurations in which a pitch angle of the linear course of the diameter of the roller outer element from the outside to the inside, i.e. from each outer side of the roller outer element to the center between the two outer sides of the roller outer element, is in particular between −10° and −30°, more particularly between −15° and −25°, more particularly −20°.

Furthermore, it is provided in particular that the roller outer element has the same width as the roller base element. In particular, however, a configuration is also provided in which the roller outer element is formed in two parts, and a respective part of the roller outer element encloses the roller center element to the left and to the right, the roller outer element projecting beyond the roller center element. The roller outer element may be formed in particular in two parts in this case.

According to a further, advantageous configuration, the ratio of the outside diameter of the roller outer element, i.e. the diameter at the outer sides of the roller outer element, in particular the maximum diameter of the roller outer element, to the largest diameter, i.e. the maximum diameter, of the roller center element is between 1 and 2, more particularly between 1.3 and 1.7, more particularly 1.5. The ratio of the inside diameter of the roller outer element, i.e. the diameter in the center region of the roller outer element, in particular the minimum diameter of the roller outer element, is advantageously greater than 1 and is in particular between 1 and 1.3, more particularly 1.1. Advantageously, the pressing roller in this way has a particularly suitable amount of “excess” soft material, as a result of which a particularly good “rebound” effect is obtained.

In particular, it is provided that the roller outer element is at least partially made of foam rubber, in particular completely made of foam rubber. If both the roller center element and the roller outer element are made of foam rubber, the foam rubber of the roller outer element is preferably elastically more resilient than the foam rubber of the roller center element.

A further, advantageous configuration provides that the roller outer element is at least partially made of polyurethane, in particular completely made of polyurethane. Advantageously, the material of the roller outer element has the following or similar material properties, similar material properties being in particular material properties having values which differ by up to 15%: resilience of 55%; compression hardness of 0.05 N/mm² at 10% compression in the third loading cycle; static modulus of elasticity of 0.2 N/mm² at a pressure of 0.042 N/mm²; dynamic modulus of elasticity of 0.65 N/mm² at a pressure of 0.042 N/mm² and 10 Hz. Such a material advantageously makes it possible to compensate for angular deviations of a component flange that is to be cleaned, in that the pressure roller “rebounds” particularly well.

According to a further, advantageous configuration, the ratio of the width of the roller center element in the region of largest diameter of the roller center element to the width of the roller base element is between 0.18 and 0.35, in particular between 0.2 and 0.25. If the diameter of the roller center element is constant, the ratio of the width of the roller center element to the width of the roller base element is advantageously between 0.18 and 0.35, in particular between 0.2 and 0.25. This ratio advantageously ensures that both a sufficient force can be exerted by the pressing roller during the cleaning operation and the desired “rebound” effect is obtained.

The ratio of the maximum diameter of the roller center element to the diameter of the roller base element, in particular to the diameter of the roller base element at the outer sides of the pressing roller, is advantageously between 1.5 and 2.5, in particular between 1.8 and 2.2, more particularly 2. Such a ratio has proven to be advantageous in tests in the case of more complicated component geometries as regards the cleaning result that can be achieved.

A further, advantageous configuration provides that the roller center element and the roller outer element are applied as coatings to the roller base element. Advantageously, a pressing roller can be produced cost-effectively in this way. Furthermore, good durability is obtained by such a configuration.

In the various figures, identical parts are generally provided with the same reference signs and are therefore also, in some cases, each explained only in conjunction with one of the figures.

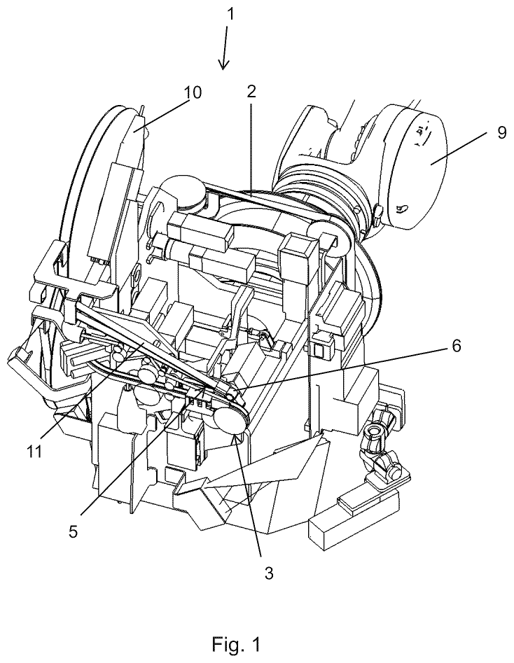

FIG. 1 shows an exemplary embodiment of a mobile application apparatus 1 arranged on a robot arm 9 and intended for applying a seal profile 2 to a body component serving to close a body opening. The application apparatus 1 has a roll-on head 3 for applying the seal profile 2 to a receiving surface of the body component, and a cleaning unit 5 intended for mechanical cleaning of the receiving surface and positioned at the front of the roll-on head 3 with respect to the receiving surface of the body component. The cleaning unit 5 comprises a pressing roller 6 and a mechanical cleaning element 11, which in this exemplary embodiment is in the form of a band-like cleaning fleece. In this exemplary embodiment, the cleaning unit 5 comprises a drivable roller assembly 51, the cleaning unit 5 with the roller assembly 51 being designed to guide the cleaning element 11 with a circular movement independently of the application movement of the roll-on head 3 along the receiving surface, the pressing roller 6 pressing the cleaning element 11 against the receiving surface that is to be cleaned.

The pressing roller 6 comprises a roller base element which is rotationally symmetrical with respect to an axis of rotation of the pressing roller 6 and is made of a first material with a first hardness value, the roller base element extending over the width of the pressing roller 6. Furthermore, the pressing roller 6 in this exemplary embodiment comprises a roller center element which is rotationally symmetrical with respect to the axis of rotation of the pressing roller 6 and is made of a second material with a second hardness value. The roller center element is arranged centrally on the roller base element and has, in the region of the maximum diameter of the roller center element, a smaller width than the roller base element. The pressure roller 6 further comprises a roller outer element which is rotationally symmetrical with respect to the axis of rotation of the pressing roller 6 and is made of a third material with a third hardness value, the roller outer element being arranged on the roller base element and on the roller center element and completely surrounding the roller center element. In this exemplary embodiment, the first hardness value is greater than the second hardness value, and the second hardness value is greater than the third hardness value. Thus, the roller outer element is softer than the roller center element, and the roller center element is softer than the roller base element.

In the exemplary embodiment shown in FIG. 1, the application apparatus 1 also comprises further, different functional modules, such as a drilling unit 10, which is however not described further here.

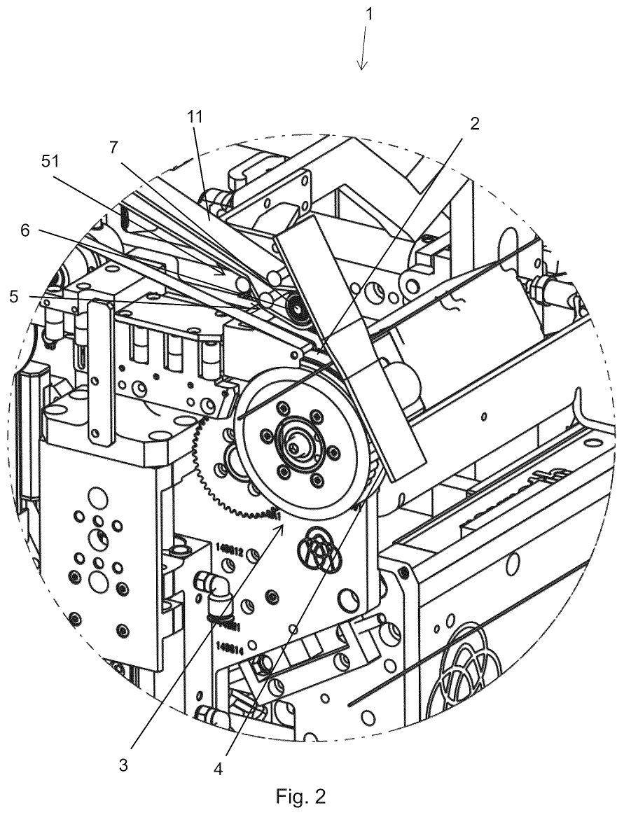

A detail of a further exemplary embodiment of an application apparatus 1 designed according to the invention is shown in FIG. 2. The application apparatus 1 according to FIG. 2 comprises substantially the same features as the application apparatus 1 explained with reference to FIG. 1, with FIG. 2 showing the cleaning unit 5 with the roller assembly 51, the mechanical cleaning element 11 and the pressing roller 6 in more detail. In addition, FIG. 2 illustrates by way of example a detail of a receiving surface 4 of a body component; after the receiving surface 4 has been cleaned by the cleaning unit 5, a seal profile 2 is applied to the receiving surface using the roll-on head 3.

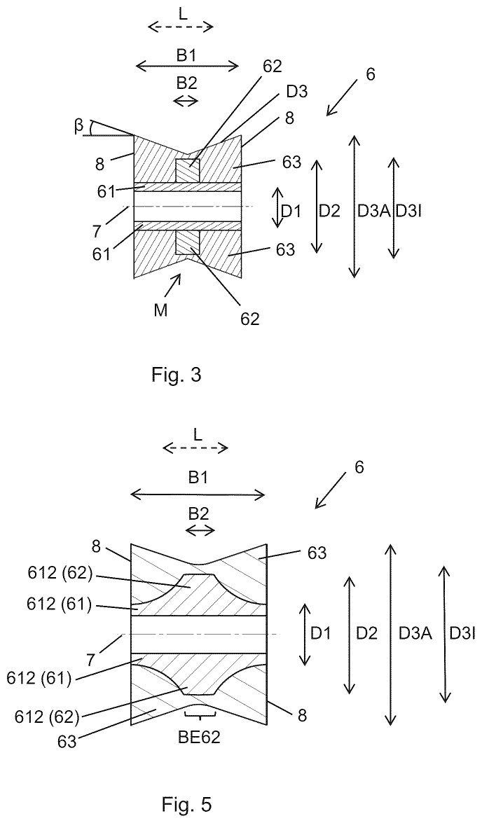

FIG. 3 shows a sectional illustration in the longitudinal direction L of the pressing roller 6 of one advantageous configuration of a pressing roller 6, in particular of the pressing roller 6 of the application apparatus 1 according to FIG. 1 or according to FIG. 2. In this exemplary embodiment, the pressing roller 6 comprises a roller base element 61 which is rotationally symmetrical with respect to an axis of rotation 7 of the pressing roller 6 and is made of a first material, the roller base element 61 extending over the entire width B1 of the pressing roller 6. In this exemplary embodiment, the width B1 of the pressing roller is 18 mm. The roller base element 61 of the pressing roller 6 has a constant diameter D1 over its direction of longitudinal extent L, in this embodiment the diameter being 8 mm. In this exemplary embodiment, the wall thickness of the roller base element 61 is 1.2 mm. In this exemplary embodiment, the material of which the roller base member 61 is made is an aluminium-zinc alloy.

The pressing roller 6 further comprises a roller center element 62 which is rotationally symmetrical with respect to the axis of rotation 7 of the pressing roller 6 and is made of a second material, which in this exemplary embodiment is a polyurethane material. The second material therefore has a higher elasticity than the first material. The roller center element 62 is arranged centrally on the roller base element 61 and has a width B2 which has been made smaller than the width B1 of the roller base element 61. In this exemplary embodiment, the width B2 of the roller center element 62 is 4 mm. In this exemplary embodiment, the ratio of the width B2 of the roller center element 62 to the width B1 of the roller base element 61 is thus approximately 0.22. The roller center element 62 of the pressing roller 6 has a constant diameter D2 over its direction of longitudinal extent L. In this exemplary embodiment, this diameter D2 is 16 mm. In this exemplary embodiment, the ratio of the diameter D2 of the roller center element 62 to the diameter D1 of the roller base element 61 is thus 2.

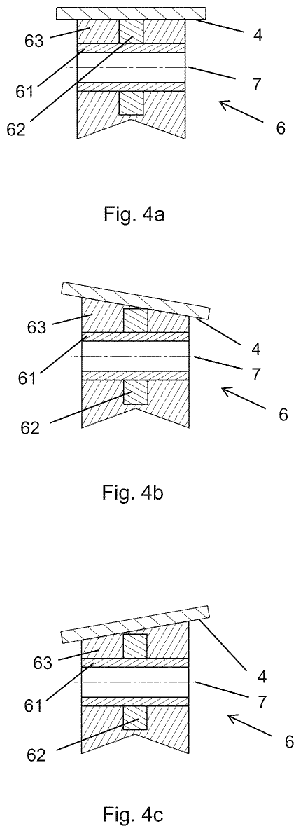

Furthermore, the pressing roller 6 comprises a roller outer element 63 which is made of a third material and is rotationally symmetrical with respect to the axis of rotation 7 of the pressing roller 6. In this exemplary embodiment, the third material provided is a further polyurethane material which has a higher elastic resilience than the polyurethane material of which the roller center element 62 is made. In particular, the polyurethane material of the roller center element 62 is designed such that it substantially does not deform during use of the pressing roller 6, whereas the polyurethane material of the roller outer element 63 is designed such that it can elastically deform during use of the pressing roller 6, as illustrated in particular in FIG. 4a to FIG. 4c. The roller outer element 63 is, as shown in FIG. 3, arranged on the roller base element 61 so as to surround the roller center element 62 and is arranged on the roller center element 62. The roller outer element 63 has the same width B1 as the roller base element 61, i.e. also in this exemplary embodiment a width B1 of 18 mm.

In this exemplary embodiment, the roller outer element 63 of the pressing roller 6 also has a decreasing diameter D3 from its outer sides 8 to the center M over its direction of longitudinal extent L. The diameter D3 of the roller outer element 63 decreases in each case linearly from the outer sides 8 of the roller outer element 63 to the center M of the roller outer element 63. In this exemplary embodiment, at the outer sides 8 the diameter D3A of the roller outer element 63 is 24 mm and decreases to the diameter D3I towards the center M. In this exemplary embodiment, the pitch angle β of the linear course of the diameter D3 of the roller outer element 63 from the respective outer side 8 to the center M is −20°, the ratio of the diameter D3A of the roller outer element 63 at the outer sides 8 to the diameter D2 of the roller center element 62 is 1.5.

In this exemplary embodiment, the roller center element 62 and the roller outer element 63 are applied as coatings to the roller base element 61 and thus form a unit that cannot be detached without destruction of the pressing roller 6, which can be mounted with the roller base element 61 on a shaft or on a bearing, in particular on a rolling bearing.

FIG. 4a to FIG. 4c show a schematic illustration, by way of example, of how the pressing roller 6 according to FIG. 3 is adapted, in the same alignment, to angular deviations with respect to the receiving surface 4 that is to be cleaned by the “rebounding” of the elastic material of the roller outer element 63. Due to the decreasing diameter D3 of the roller outer element 63 from the outer sides 8 to the center M, the “excess” soft material in the outer regions can advantageously also achieve a stronger “rebound” effect.

FIG. 5 illustrates a sectional illustration in the longitudinal direction L of the pressing roller 6 of a further configuration of a pressing roller 6 which can also be used in particular with an application apparatus 1 illustrated in FIG. 1 or FIG. 2. In this exemplary embodiment, the pressing roller 6 comprises a roller base element 61 which is rotationally symmetrical with respect to an axis of rotation 7 of the pressing roller 6 and a roller center element 62 which is rotationally symmetrical with respect to the axis of rotation 7 of the pressing roller 6, the roller base element 61 and the roller center element 62 being formed together in one piece and thus together forming a roller base center element 612. In this exemplary embodiment, this roller base center element 612 is made of metal, in particular an aluminium alloy.

Furthermore, the pressing roller 6 comprises a roller outer element 63 which is rotationally symmetrical with respect to the axis of rotation 7 of the pressing roller 6 and is made of polyurethane, which is elastically resilient and in particular elastically compressible, in particular like the roller outer element 63 shown in FIG. 4a to FIG. 4c. The roller outer element 63 in this respect has a significantly lower hardness than the roller base center element 612.

The roller base element 61, which in this exemplary embodiment seamlessly transitions into the roller center element 62, extends over the entire width B1 of the pressing roller 6. The roller center element 62, in particular the region BE62 of maximum diameter D2 of the roller center element 62, is arranged centrally with respect to the roller base element 61 and, in the region BE62 of largest diameter D2 of the roller center element 62, has a smaller width B2 than the roller base element 61.

The roller outer element 63 is arranged on the roller base center element 612 so as to surround the roller base center element 612, in particular is applied as a coating to the roller base center element 612. The ratio of the maximum diameter D3A of the roller outer element 63 at the outer sides 8 of the pressing roller 6 to the largest diameter D2 of the roller center element 62 is between 1 and 2; in FIG. 5 it is approximately 1.5.

As illustrated in FIG. 5, in this exemplary embodiment the roller center element 62 of the pressing roller 6 has a constant diameter D2 over its direction of longitudinal extent L only in the region BE62. The diameter of the roller base center element 612 increases from the outer sides 8 from the minimum diameter D1 to the maximum diameter D2, as illustrated in FIG. 5, in particular in accordance with a quadratic function.

Like in the exemplary embodiment according to FIG. 3, the roller outer element 63 of the pressing roller 6 has a maximum diameter D3A at its outer sides 8 over its direction of longitudinal extent L which decreases to the minimum diameter D3I towards the center M. The roller outer element 63 has the same width B1 as the roller base element 61.

The ratio of the width B2 of the roller center element 62 in the region BE62 of largest diameter D2 to the width B1 of the roller base element 61 is between 0.18 and 0.35. The ratio of the diameter of the maximum diameter D2 of the roller center element 62 to the minimum diameter D1 of the roller base element 61 is between 1.5 and 2.5; in FIG. 5 it is approximately 2.

The exemplary embodiments illustrated in the figures and explained in conjunction therewith serve to explain the invention and have no limiting effect thereon.

### LIST OF REFERENCE SIGNS

1 Application apparatus
2 Seal profile
3 Roll-on head
4 Receiving surface of the body component
5 Cleaning unit
51 Roller assembly
6 Pressing roller
61 Roller base element
62 Roller center element
612 Roller base center element
63 Roller outer element
7 Axis of rotation
8 Outer side of the roller outer element (63)
9 Robot arm
10 Drilling unit
11 Mechanical cleaning element
B1 Width of the pressing roller (6)
B2 Width of the roller center element (62)
D1 Diameter of the roller base element (61)
D2 Diameter of the roller center element (62)
D3 Diameter of the roller outer element (63)
D3A Diameter of the roller outer element (63) at the outer sides (8)
D3I Diameter of the roller outer element (63) in the center (M)
M Center of the roller outer element (63)
BE62 Region of maximum diameter (D2) of the roller center element (62)
L Direction of longitudinal extent
β Pitch angle

1. An application apparatus for applying a seal profile to a body component serving to close a body opening, comprising:
a roll-on head for applying the seal profile to a receiving surface of the body component; and
a cleaning unit for mechanical cleaning of the receiving surface and positioned at the front of the roll-on head with respect to the receiving surface of the body component;
wherein the cleaning unit includes a pressing roller;
wherein the pressing roller includes a roller base element which is rotationally symmetrical with respect to an axis of rotation of the pressing roller and is made of a first material;
wherein the roller base element extends over the width of the pressing roller;
wherein the pressing roller includes a roller center element which is rotationally symmetrical with respect to the axis of rotation of the pressing roller and is made of a second material;
wherein the roller center element is arranged centrally with respect to the roller base element and has, at least in a region of a largest diameter of the roller center element, a smaller width than the roller base element;
wherein the pressing roller includes a roller outer element which is rotationally symmetrical with respect to the axis of rotation of the pressing roller and is made of a third material;
wherein the roller outer element is arranged on the roller base element so as to surround the roller center element and is arranged on the roller center element;
wherein the third material has a lower hardness than the second material and the first material.

2. The application apparatus according to claim 1, wherein the roller base element is formed in one piece together with the roller center element, wherein the first material corresponds to the second material.

3. The application apparatus according to claim 1, wherein the roller center element is arranged on the roller base element.

4. The application apparatus according to claim 3, wherein the second material is a different material from the first material, and the second material has a lower hardness than the first material.

5. The application apparatus according to claim 1, wherein the roller base element of the pressing roller has a constant diameter over its direction of longitudinal extent.

6. The application apparatus according to claim 1, wherein the roller center element of the pressing roller has a constant diameter over its direction of longitudinal extent.

7. The application apparatus according to claim 1, wherein the roller outer element of the pressing roller has a decreasing diameter from its outer sides to the center over its direction of longitudinal extent.

8. The application apparatus according to claim 7, wherein the diameter of the roller outer element linearly decreases from each outer side of the roller outer element to the center of the roller outer element.

9. The application apparatus according to claim 8, wherein the pitch angle of the linear course of the diameter of the roller outer element from each outer side to the center is between −10° and −30°.

10. The application apparatus according to claim 1, wherein the roller outer element has the same width as the roller base element.

11. The application apparatus according to claim 1, wherein the ratio of the width of the roller center element in the region of largest diameter to the width of the roller base element is between 0.18 and 0.35.

12. The application apparatus according to claim 1, wherein the ratio of the maximum diameter of the roller center element to the diameter of the roller base element is between 1.5 and 2.5.

13. The application apparatus according to claim 1, wherein the ratio of the diameter of the roller outer element at the outer sides to the greatest diameter of the roller center element is between 1 and 2.

14. The application apparatus according to claim 1, wherein the roller base element is at least partially made of metal.

15. The application apparatus according to claim 1, wherein the roller center element is at least partially made of foam rubber, and/or the roller outer element is at least partially made of foam rubber.

16. The application apparatus according to claim 1, wherein the roller center element is at least partially made of polyurethane and/or the roller outer element is at least partially made of polyurethane.

17. The application apparatus according to claim 1, wherein the roller center element and the roller outer element are applied as coatings to the roller base element; or the roller outer element is applied as a coating to the roller base element and to the roller center element.
